(19) United States
(12) Patent Application Publication
(10) Pub. No.: US 2025/0392560 A1
(43) Pub. Date: Dec. 25, 2025

(54) THINK TWICE ELECTRONIC COMMUNICATION OUTPUT FILTER GUARD

(71) Applicant: Bank of America Corporation, Charlotte, NC (US)

(72) Inventors: Hugo Christopher Maxwell Beales, London (GB); Manu Kurian, Dallas, TX (US)

(21) Appl. No.: 18/748,310

(22) Filed: Jun. 20, 2024

(51) Int. Cl. H04L 51/212; G06F 40/20; H04L 9/40

(52) U.S. Cl. CPC H04L 51/212; H04L 63/0876; G06F 40/20

(57) ABSTRACT

Systems, methods, and apparatus may be provided for filtering outgoing electronic communications that are generated at user devices using an artificial intelligence (AI) filtering system operating in a quantum computing environment. The hybrid AI/quantum system filters the electronic communications before transmission to recipients. The AI filter may include an AI model that has been trained with an electronic record of historical communications for the user. The AI filtering at the quantum computer may check outgoing electronic communications for incorrect or missing information. Electronic communications with identified issues may be flagged to a user, and changes to the communications may be suggested. A flagged electronic communications may be released for transmission to the recipients after the user modifies the electronic communication or may be released by the user without making changes. Electronic communications to be filtered may include, for example, emails, text messages, or instant messages.

### FIELD OF TECHNOLOGY

Aspects of the disclosure relate to an artificial intelligence (AI) filter at a quantum computing system to filter outgoing electronic communications from a user device.

### BACKGROUND OF THE DISCLOSURE

Often, electronic communications get sent by a user without the user double checking the contents of the electronic communications. Thus, the user may not notice one or more mistakes in the electronic communications. Mistakes in an electronic communication may include, for example, a wrong recipient, a wrong attachment, incorrect content, or spelling or grammar mistakes.

It would therefore be desirable to provide a system with which to filter outgoing electronic communications so that mistakes in the electronic communications may be quickly identified and corrected with insignificant delay to maintain transmission speeds of the outgoing electronic communications.

### SUMMARY OF THE DISCLOSURE

Systems, methods, and apparatus may be provided for a quantum computing system that utilizes an AI filter engine to analyze outgoing electronic communications. The AI filter engine may include an AI model that may be trained based on historical electronic communications of the user that have been stored. The AI model may use machine learning (ML). The quantum computing system may use the AI filter engine to analyze the outgoing electronic communications to check outgoing electronic communications for data that are not consistent with historical data for past electronic communications involving the user. The presence of data in an outgoing electronic communication that is inconsistent with historical data may indicate that the outgoing electronic communication includes wrong or missing information.

The AI filtering by a quantum computing system (quantum filter system) may be invoked in an outbox of an electronic communication system. AI filtering on a quantum computing system may operate at a speed that is greater than the speed of the electronic communication system.

The quantum filter system may monitor and check the contents of outgoing electronic communications using an AI filter. The quantum filter system may monitor and check the contents of every outgoing electronic communication. The quantum filter system may monitor and check the contents of some outgoing electronic communications. The quantum filter system may prevent the transmission of any electronic communication that is flagged as including wrong (incorrect) or missing information. The quantum filter system may return the flagged electronic communications to the user who is the sender of the electronic communication for review. The quantum filter system may suggest changes, such as corrections based on the historical data, to be made to a flagged electronic communication before the electronic communication is forwarded to the intended recipient(s) of the electronic communication. If changes are suggested to the user, the user may have an option to decide whether to quickly revise the flagged electronic communication with one or more of the suggested changes, make changes other than those that are suggested, or to send the electronic communication as is, without change. The user may decide to make other changes based on the suggestions or proceed with one of the other options. Thus, the quantum AI filter may permit a user to “think twice” about an electronic communication that is to be transmitted. The quantum filter system may update itself and improve its output as it monitors electronic communications. The monitoring of the electronic communications may be continuous.

One or more non-transitory computer-readable media storing computer-executable instructions, when executed on a quantum processor on a computer system, may perform a method for filtering outgoing electronic communications generated at a user device prior to transmission to recipients using AI operating in a quantum computing environment in accordance with principles of the present disclosure. The method may include receiving, at a quantum computing system that includes a quantum processor, an electronic communication of the outgoing electronic communications to be transmitted from a first user device to a second user device. The method may include initiating, by the quantum processor, an AI filter engine for analyzing the electronic communication that is received in order to determine whether the electronic communication is consistent with an electronic record of historical communications in which the user has engaged. The quantum processor may process data as a plurality of qubits. When the quantum processor determines that the electronic communication is consistent with the electronic record of historical communications, the method may include authorizing, by the AI filter engine, the electronic communication to be transmitted to the second user device. When the quantum processor determines that the electronic communication is inconsistent with the electronic record of historical communications, the method may include flagging, by the AI filter engine, the electronic communication for review.

The AI filter engine may include an AI model that has been trained with the electronic record of historical communications in which the user has engaged by reviewing contents of each of the outgoing electronic communications. The quantum processor may be configured to analyze the electronic communication that is received to determine whether the electronic communication is consistent with the AI model.

The quantum processor may be configured to determine consistency of the electronic communication with the electronic record by checking the electronic communication for incorrect or missing information. The incorrect information may include, for example, one or more of an incorrect email address or phone number, an incorrectly identified recipient, one or more spelling or grammatical mistakes, an incorrect attachment, or inappropriate or undesirable information.

The method may include blocking, by the quantum processor, a flagged electronic communication from being transmitted to the second user device. The method may include returning a flagged electronic communication to the first user device and not transmitting the flagged electronic communication to the second user device. The method may include suggesting, by the AI filter engine to the first user device, changes to a flagged electronic communication based on the electronic record. The suggested changes may make the flagged electronic communication consistent with the electronic record of historical communications to enable the flagged electronic communication to be transmitted to the second user device without being blocked. The method may include updating the electronic record of historical communications upon transmission of the electronic communication.

The electronic record of historical electronic communications may include one or more of emails, text messages, or instant messages.

The quantum computing system may analyze the electronic communications in real time.

A method for filtering outgoing electronic communications generated at a user device prior to transmission to recipients using AI operating in a quantum computing environment may be provided in accordance with principles of the present disclosure. The method may include receiving, at a quantum computing system that includes a quantum processor, an electronic communication of the outgoing electronic communications to be transmitted from a first user device to a second user device before the transmission is performed. The method may include initiating, by the quantum processor, an AI filter engine for analyzing the electronic communication that is received in order to determine whether the electronic communication is consistent with an electronic record of historical communications in which the user has engaged. The quantum processor may process data as a plurality of qubits. When the quantum processor determines that the electronic communication is consistent with the electronic record of historical communications, the method may include authorizing, by the quantum processor, the electronic communication to be transmitted to the second user device. When the quantum processor determines that the electronic communication is inconsistent with the electronic record of historical communications, the method may include flagging, by the quantum processor, the electronic communication for review.

The AI filter engine may include an AI model that has been trained with the electronic record of historical communications in which the user has engaged by reviewing contents of each of the outgoing electronic communications. The quantum processor may be configured to analyze the electronic communication that is received to determine whether the electronic communication is consistent with the AI model.

The quantum processor may be configured to determine consistency of the electronic communication with the electronic record by checking the electronic communication for incorrect or missing information. The incorrect information may include, for example, one or more of an incorrect email address or phone number, an incorrectly identified recipient, one or more spelling or grammatical mistakes, an incorrect attachment, or inappropriate or undesirable information.

The method may include blocking, by the quantum processor, a flagged electronic communication from being transmitted to the second user device. The method may include returning a flagged electronic communication to the first user device and not transmitting the flagged electronic communication to the second user device. The method may include suggesting, by the quantum processor to the first user device, changes to a flagged electronic communication based on the AI model to make the flagged electronic communication consistent with the electronic record to enable the flagged electronic communication to be transmitted to the second user device without being blocked. The method may include updating the electronic record of historical communications upon transmission of the electronic communication. The electronic record of historical electronic communications may include one or more of emails, text messages, or instant messages.

The quantum computing system may analyze the electronic communications in real time.

### BRIEF DESCRIPTION OF THE DRAWINGS

The objects and advantages of the disclosure will be apparent upon consideration of the following detailed description, taken in conjunction with the accompanying drawings, in which like reference characters refer to like parts throughout, and in which:

FIG. 1 shows illustrative apparatus in accordance with principles of the disclosure.

FIG. 2 shows illustrative apparatus in accordance with principles of the disclosure.

FIG. 3 shows an illustrative diagram in accordance with principles of the disclosure.

FIG. 4 shows an illustrative diagram in accordance with principles of the disclosure.

FIGS. 5A and 5B show illustrative diagrams in accordance with the principles of the disclosure.

FIG. 6 shows an illustrative diagram in accordance with the principles of the disclosure.

FIG. 7A shows an illustrative email that may be prepared by a user for transmission after the email has been filtered and flagged for review in accordance with the principles of the disclosure.

FIG. 7B shows an illustrative email that may be prepared by a user for transmission after corrections have been made to the email shown in FIG. 7A in accordance with the principles of the disclosure.

FIG. 8 shows an illustrative process flow in accordance with the principles of the disclosure.

### DETAILED DESCRIPTION

Quantum computing systems may provide tremendous advantages over standard data processing and storage of standard computing systems. In standard (i.e., classical or binary) computing, bits hold only one of two values, and the number of states is limited. In quantum computing, entangled qubits may hold all possible values at the same time, enabling many more states. As such, quantum computing systems may work much faster and handle much more data than standard computers. Quantum algorithms may create multidimensional computational spaces, allowing quantum computing to more efficiently and more quickly solve complex problems that are beyond the reach of standard computing.

Systems, methods, and apparatus may be provided for monitoring and filtering electronic communications to review outgoing electronic communications that are generated at one or more user devices using an AI filter operating in a quantum computing environment. This hybrid of an AI filter and quantum computing may be termed a quantum filter guard. The AI filtering of a user's electronic communications in a quantum computing environment may be configured so that it is always on, or the user may be enabled to turn the filtering on and off, as desired. The filtering may be enabled to be performed on a subset of a user's electronic communications, such as filtering outgoing communications to only specific recipient(s). The quantum filter guard may be used to simultaneously filter, using AI in a quantum computing environment, electronics communications generated at multiple user devices.

Electronic communications to be sent from a user device may be monitored and filtered by the AI filter in a quantum computing environment prior to transmission to one or more recipients or group of recipients. The AI filter may review the electronic communications, for example, for mistakes or other problems with the contents of the electronic communications, such as wrong or missing information in the electronic communications. The electronic communications may take various forms, such as email, text, or instant messages. The quantum computing system may include a quantum computer. The quantum computer may include a quantum processor. The quantum processor may process data as a plurality of qubits.

For example, the quantum computer that monitors outgoing electronic communications from a first user device may receive an outgoing electronic communication to be transmitted from a first user device to a second user device before the electronic communication is forwarded to the second user device. The quantum computer at the quantum computer system may operate an AI filter engine that is configured to analyze each electronic communication that is received to determine whether the electronic communications are consistent with an electronic record of historical communications in which the user has engaged in the past. The AI filter engine may use an AI model that has been trained to analyze historical communications in the electronic communication system. The electronic communications to be filtered may take various forms, such as emails, text messages, or instant messages. The electronic record of historical electronic communications of a user may include one or more of previous emails, text messages, or instant messages, or other types of electronic communications, such as letters or other documents that have been saved electronically. The historical electronic communications may be electronic communications of the user of the first user device.

The AI filter engine may be trained, using the electronic record of historical communications for a user, to analyze the outgoing electronic communications from a user. The electronic record of historical communications may be stored in a memory at the user device to train the AI filter engine to filter the outgoing electronic communication. The electronic record may include an outbox of an electronic communication system. The electronic record may be stored in a memory at a standard computing system in communication with the user device. The standard computing system may also include the electronic communications system used to transmit the electronic communication. The electronic record may be stored in a memory at the quantum computing system.

The AI filter engine may be configured to determine that an electronic communication is consistent with the electronic record of historical communications by the user with others. In this case, the quantum computer may authorize the electronic communication from the first user device to be transmitted to the second user device. The AI filter engine may be configured to determine that the electronic communication is inconsistent with the electronic record of historical communications. In that case, the quantum computer may be configured to flag the electronic communication. The flagging of the electronic communication may be recorded in any suitable location, such as in a memory at the quantum computer. The AI filter engine may be configured to analyze the electronic communication that is received to determine whether the electronic communication is consistent with an electronic record of historical communications in which the user has engaged by reviewing contents of each of the outgoing electronic communications.

The electronic communications may also be checked for consistency with other information related to the intended recipient, such as names, addresses, phone numbers and notes about the recipient, stored by the user in an electronic database. This may enhance the filtering of the outgoing electronic communications and may be used by the AI-filter engine to autocorrect errors or suggest changes to the communications.

The AI filter engine may be configured to train an AI model used by the AI filter engine to analyze the electronic record of historical communications for a user to select data within the electronic record to be used in the analysis of consistency of the electronic communication with the electronic record. The user may be associated with the user device used to generate the electronic communication. The AI filter engine may be configured to determine consistency of the electronic communication with the electronic record by checking the electronic communication for wrong or missing information.

Wrong information in the electronic communication that is prepared by the user may include, for example, one or more of an incorrect email address or phone number of a recipient, an incorrectly identified recipient, spelling or grammatical mistakes, a wrong attachment, inappropriate or undesirable information, spelling or grammar mistakes, or incorrect content. For example, the electronic communication may include a wrong phone number. The electronic communication may refer to an incorrect name of a relative or colleague. The electronic communication may include a typo, or the electronic communication may include an attachment that appears to pertain to a different party other than the intended recipient. The electronic communication may include other types of incorrect information for which the AI filter may check. Missing information may include, for example, information that is referenced in the electronic communication but was not included or attached, such as a form paragraph that may be usually included in a communication to the specified recipient, an attachment that is not attached, a missing signature block, an abbreviation that was not spelled out, or other types of missing information.

The quantum processor may be configured to block a flagged electronic communication from being transmitted to the second user device. The quantum processor may be configured to return a flagged electronic communication to the first user device. The quantum processor may be configured to suggest to the first user device changes to a flagged electronic communication based on the electronic record to make the flagged electronic communication consistent with the electronic record to enable the flagged electronic communication to be transmitted to the second user device without being blocked.

The quantum processor may be configured to update the electronic record of historical communications upon or after release of the electronic communication for transmission to the recipient.

As the quantum computing system may operate much more quickly than a user device used to generate the electronic communications and faster than an electronic transmission system, such as an email, text, or instant messaging system, the quantum computing system may be configured to monitor and filter the outgoing electronic communications before transmission in real time.

For the sake of illustration, the invention is described as being performed by a “system.” The system may include one or more features of apparatus and methods that are described herein and/or any other suitable device or approach.

The system may include a standard processor, which is a non-quantum processor, used for binary computing. The system may include a quantum processor. A quantum processor may be used herein to refer to a computing device whose operations can harness aspects of quantum mechanics, such as superposition, interference, and entanglement.

Quantum processors are associated with vastly improved efficiencies over standard computers. Standard computers represent data in bits, which can be either 0 or 1. Quantum processors use qubits which utilize superposition (i.e., the ability to be in multiple states at the same time) to allow for a state of 0, 1, or any probability of being 0 or 1. The probabilities may be manipulated using matrix-based quantum gates, which are analogous to standard logic gates. Qubits are therefore able to represent many more data possibilities than a bit-based system of the same size. This allows for greater speed and less memory usage than standard systems.

A qubit in a state of superposition may not have a defined value because it may hold many potential values at the same time. When measured, the qubit wave function collapses to a defined state. When an entangled qubit is in a state of superposition, each of its entangled connections is also in a state of superposition. These combinations of uncertainties exponentially increase the power of quantum processors.

The quantum processor may include a default number of quantum threads. Each quantum thread may include a default number of quantum circuits. Quantum circuits may refer to hardware and software based computational models that include quantum gates and are used for executing quantum computations.

In some embodiments, at least one of the quantum circuits may include a Toffoli gate. A feature of the Toffoli gate is its universal nature, meaning the structure is able to represent standard operations as well as quantum operations. In some embodiments, at least one of the quantum circuits may include a Hadamard gate. A feature of the Hadamard gate is the ability to represent a superposition state.

Quantum computing may be referred to as the use of quantum-mechanical phenomena such as superposition and entanglement to perform computations. The smallest bit in a quantum computing system may be called a qubit.

Executable instructions may be executed by an “N”-qubit processor on a computer system. “N” may be a number between two and ten thousand.

The amount of data that a quantum computing system may be able to hold and manipulate may grow exponentially with the number of qubits included in the quantum computing system's processing core. A quantum computing system with “N” qubits may be able to simultaneously represent 2^{N} states. Therefore, two qubits may hold four states, three qubits may hold eight states, fifty qubits may hold 1,125,899,906,842,624 states, and 10,000 qubits may hold 2¹⁰⁰⁰⁰ states.

Other standard components of a computer system may be present, such as communication links, displays, input and output devices, read-only and random-access memory, and other components.

The term “non-transitory memory,” as used in this disclosure, is a limitation of the medium itself, i.e., it is a tangible medium and not a signal, as opposed to a limitation on data storage types (e.g., RAM vs. ROM). “Non-transitory memory” may include both RAM and ROM, as well as other types of memory.

The non-transitory memory may be configured to store executable data configured to run on the “N”-qubit processor and/or a standard processor.

The “N”-qubit processor or standard processors may control the operation of the computer system and its components, which may include RAM, ROM, an input/output module, and other memory. Standard microprocessors or standard processors may refer to non-qubit processors.

Other components commonly used for computers, such as EEPROM or Flash memory or any other suitable components, may also be part of the apparatus and computer system.

A communication link may enable communication with other computers and servers, as well as enable the program to communicate with databases. The communication link may include any necessary hardware (e.g., antennae) and software to control the link. Any appropriate communication link may be used, such as Wi-Fi, Bluetooth, LAN, and cellular links. Multiple communication links may be present. In some embodiments, the network used to communicate may be the Internet. In some embodiments, the network may be an intranet.

The quantum computing system may include multi-dimensional scaling. The query may be routed to a quantum processor having a default number of quantum threads. Each quantum thread may include a default number of quantum circuits.

The system may automatically scale the quantum processor during filter guard operation. The scaling may include adding additional quantum circuits to each quantum thread when a task is detected to have a duration that is longer than a threshold duration. The scaling may include adding additional quantum threads when a task is detected to have a volume that is larger than a threshold volume.

Determination of the inception point, determination of the number of copies, identification of likely branches, scaling of the quantum processor, and/or any suitable operations may be carried out by one or more artificial intelligence/machine learning (AI/ML) algorithms.

An electronic communications filtering operation may initiate a quantum circuit. A quantum circuit may include one or more qubits and quantum gates. A group of qubits may be referred to as a quantum register. The quantum gates may perform operations that manipulate the quantum states of the qubits.

The quantum processor may simultaneously analyze each copy with its assigned qubits. The analysis may be carried out by any suitable algorithm or algorithms including one or more algorithms that use qubit superposition and entanglement properties.

The quantum processor may produce any suitable output. The outputs may be a result of “viewing” or “measuring” the qubits or quantum registers, collapsing a quantum probability into a discrete output (generally 0 or 1). This viewing or measuring may take place multiple times per second. The output may be digital data. The output may be displayed on a graphical user interface. The output may be transmitted to a different computer or a different part of the computer system for further analysis or computations.

A qubit-based processor may perform the filtering of the electronic communications exponentially faster than if the filtering were performed by a standard microprocessor.

In some embodiments, the system may include instructions executed by a standard (non-qubit) processor on a computer system. The computer system may be the same computer system that includes the quantum processor. The standard processor may manage quantum processor operations through one or more AI/ML algorithms. Managing may include efficiently running the quantum processor, analyzing the outputs, and/or any other suitable function.

An AI/ML manager of the quantum-based analysis may be necessary as the outputs may be too large or arrive too fast for a human operator to manage efficiently. The AI/ML algorithms may be trained using simulated training data or real world data. The AI/ML algorithms may be trained on the output iteratively. The AI/ML algorithms may be suitable for quantum processors.

In some embodiments, the quantum processor may include one or more Toffoli gates, Hadamard gates, and/or any suitable quantum logic gate.

A computer system may include both a standard processor and a quantum processor. The method may include initializing a quantum circuit at the quantum processor and operating an algorithm at the quantum circuit. When the AI filtering is complete, the method may include collapsing the quantum circuit. The quantum processor may have N qubits, where N is a number between two and ten thousand. The continuous hashing algorithm may utilize a superposition property of the N-qubit processor.

The quantum processor may include a default number of quantum threads. Each quantum thread may include a default number of quantum circuits. The method may include automatically scaling the quantum processor when operating the filtering guard. The method may include adding quantum circuits to each quantum thread when a processing task is detected to have a duration that is longer than a threshold duration. The method may include adding quantum threads when the processing task is detected to have a volume that is larger than a threshold volume.

A real-time log of the AI filtering development may also be generated at the quantum computing system. Separate logs may be saved for each user or user device that uses the filter guard at the quantum computing system. The logs may be saved for ongoing AI filtering of outgoing electronic communications for the users. The logs may be analyzed, and data therein may be fed back to the AI filtering system for analysis.

Apparatus and methods in accordance with this disclosure will now be described in connection with the figures, which form a part hereof. The figures show illustrative features of apparatus and method steps in accordance with the principles of this disclosure. It is to be understood that other embodiments may be utilized, and that structural, functional, and procedural modifications may be made without departing from the scope and spirit of the present disclosure.

The steps of methods may be performed in an order other than the order shown or described herein. Embodiments may omit steps shown or described in connection with illustrative methods. Embodiments may include steps that are neither shown nor described in connection with illustrative methods. Illustrative method steps may be combined. For example, an illustrative method may include steps shown in connection with another illustrative method.

Apparatus may omit features shown or described in connection with illustrative apparatus. Embodiments may include features that are neither shown nor described in connection with the illustrative apparatus. Features of illustrative apparatus may be combined. For example, an illustrative embodiment may include features shown in connection with another illustrative embodiment.

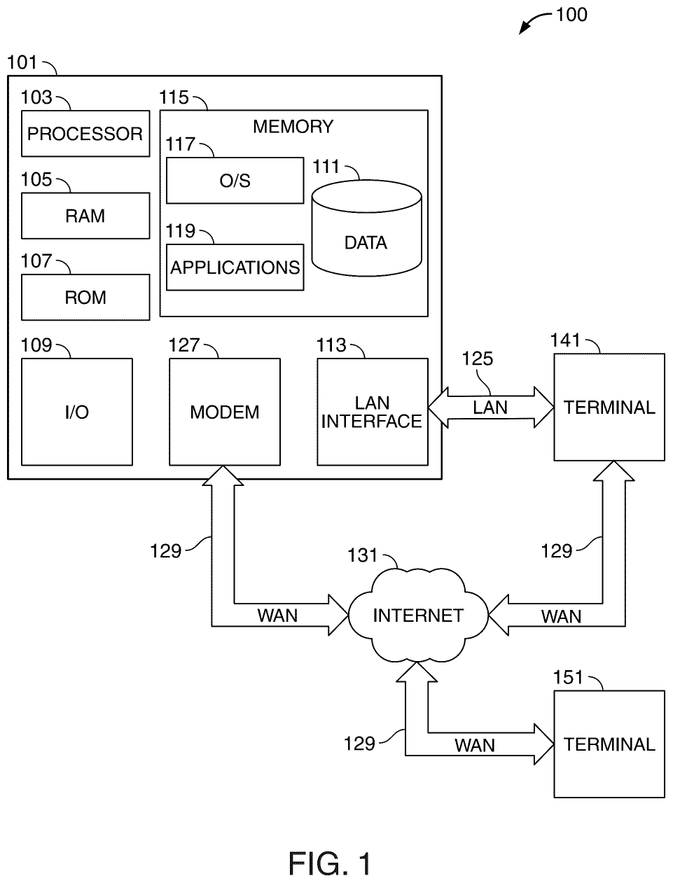

FIG. 1 shows an illustrative block diagram of system 100 that includes computer 101. Computer 101 may alternatively be referred to herein as an “engine,” “server,” or a “computing device.” Computer 101 may be a workstation, desktop, laptop, tablet, smartphone, or any other suitable computing device. Elements of system 100, including computer 101, may be used to implement various aspects of the systems and methods disclosed herein. Each of the systems, methods and algorithms illustrated below may include some or all of the elements and apparatus of system 100.

Computer 101 may include processor 103 for controlling the operation of the device and its associated components, and may include RAM 105, ROM 107, input/output (“I/O”) 109, and a non-transitory or non-volatile memory 115. Machine-readable memory may be configured to store information in machine-readable data structures. Processor 103 may also execute all software running on the computer. Other components commonly used for computers, such as EEPROM or flash memory or any other suitable components, may also be part of computer 101.

Memory 115 may include any suitable permanent storage technology, such as a hard drive. Memory 115 may store software including the operating system 117 and application program(s) 119 along with any data 111 needed for the operation of the system 100. Memory 115 may also store videos, text, and/or audio assistance files. The data stored in memory 115 may also be stored in cache memory, or any other suitable memory.

I/O module 109 may include connectivity to a microphone, keyboard, touch screen, mouse, and/or stylus through which input may be provided into computer 101. The input may include input relating to cursor movement. The input/output module may also include one or more speakers for providing audio output and a video display device for providing textual, audio, audiovisual, and/or graphical output. The input and output may be related to computer application functionality.

System 100 may be connected to other systems via a local area network (LAN) interface 113. System 100 may operate in a networked environment supporting connections to one or more remote computers, such as terminals 141 and 151. Terminals 141 and 151 may be personal computers or servers that include many or all of the elements described above relative to system 100. The network connections depicted in FIG. 1 include a local area network (LAN) 125 and a wide area network (WAN) 129 but may also include other networks. When used in a LAN networking environment, computer 101 may connect to LAN 125 through LAN interface 113 or an adapter. When used in a WAN networking environment, computer 101 may include modem 127 or other means for establishing communications over WAN 129, such as Internet 131.

It will be appreciated that the network connections shown are illustrative and other means of establishing a communications link between computers may be used. The existence of various well-known protocols such as TCP/IP, Ethernet, FTP, HTTP and the like is presumed, and the system can be operated in a client-server configuration to permit retrieval of data from a web-based server or application programming interface (API). Web-based, for the purposes of this application, is to be understood to include a cloud-based system. The web-based server may transmit data to any other suitable computer system. The web-based server may also send computer-readable instructions, together with the data, to any suitable computer system. The computer-readable instructions may include instructions to store the data in cache memory, the hard drive, secondary memory, or any other suitable memory.

Additionally, application program(s) 119, which may be used by computer 101, may include computer executable instructions for invoking functionality related to communication, such as e-mail, Short Message Service (SMS), and voice input and speech recognition applications. Application program(s) 119 (which may be alternatively referred to herein as “plugins,” “applications,” or “apps”) may include computer executable instructions for invoking functionality related to performing various tasks. Application program(s) 119 may utilize one or more algorithms that process received executable instructions, perform power management routines or other suitable tasks. Application program(s) 119 may utilize one or more decisioning processes for mirror mode operations as described herein.

The invention may be described in the context of computer-executable instructions, such as application(s) 119, being executed by a computer. Generally, programs include routines, programs, objects, components, data structures, etc., that perform particular tasks or implement particular data types. The invention may also be practiced in distributed computing environments where tasks are performed by remote processing devices that are linked through a communications network. In a distributed computing environment, programs may be located in both local and remote computer storage media including memory storage devices. It should be noted that such programs may be considered, for the purposes of this application, as engines with respect to the performance of the particular tasks to which the programs are assigned.

Computer 101 and/or terminals 141 and 151 may also include various other components, such as a battery, speaker, and/or antennas (not shown). Components of computer system 101 may be linked by a system bus, wirelessly or by other suitable interconnections. Components of computer system 101 may be present on one or more circuit boards. In some embodiments, the components may be integrated into a single chip. The chip may be silicon-based.

Terminal 141 and/or terminal 151 may be portable devices such as a laptop, cell phone, tablet, smartphone, or any other computing system for receiving, storing, transmitting and/or displaying relevant information. Terminal 141 and/or terminal 151 may be one or more user devices. Terminals 141 and 151 may be identical to system 100 or different. The differences may be related to hardware components and/or software components.

The invention may be operational with numerous other general purpose or special purpose computing system environments or configurations. Examples of well-known computing systems, environments, and/or configurations that may be suitable for use with the invention include, but are not limited to, personal computers, server computers, hand-held or laptop devices, tablets, mobile phones, smart phones and/or other personal digital assistants (“PDAs”), multiprocessor systems, microprocessor-based systems, cloud-based systems, programmable consumer electronics, network PCs, minicomputers, mainframe computers, distributed computing environments that include any of the above systems or devices, and the like.

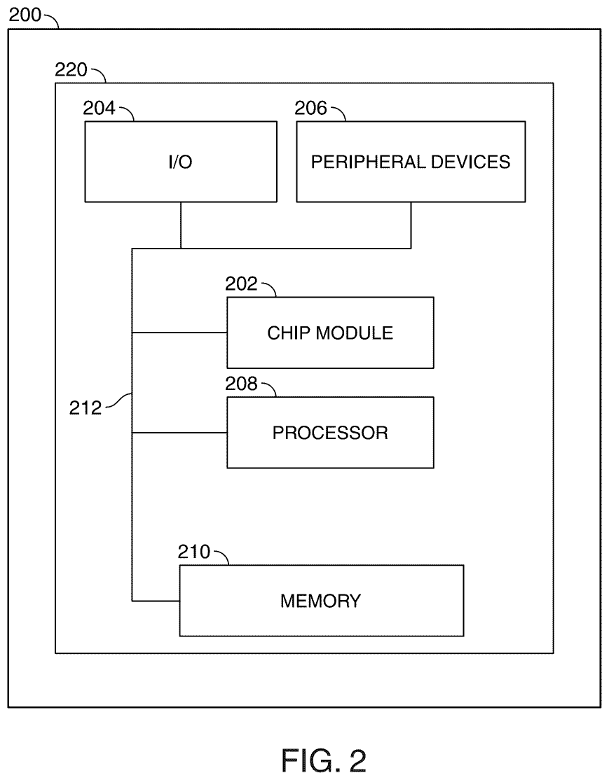

FIG. 2 shows illustrative apparatus 200 that may be configured in accordance with the principles of the disclosure. Apparatus 200 may be a computing device. Apparatus 200 may include one or more features of the apparatus shown in FIG. 2. Apparatus 200 may include chip module 202, which may include one or more integrated circuits, and which may include logic configured to perform any suitable logical operations.

Apparatus 200 may include one or more of the following components: I/O circuitry 204, which may include a transmitter device and a receiver device and may interface with fiber optic cable, coaxial cable, telephone lines, wireless devices, PHY layer hardware, a keypad/display control device or any other suitable media or devices; peripheral devices 206, which may include counter timers, real-time timers, power-on reset generators or any other suitable peripheral devices; logical processing device 208, which may compute data structural information and structural parameters of the data; and machine-readable memory 210.

Machine-readable memory 210 may be configured to store in machine-readable data structures: machine executable instructions, (which may be alternatively referred to herein as “computer instructions” or “computer code”), applications such as applications 219, signals, and/or any other suitable information or data structures.

Components 202, 204, 206, 208, and 210 may be coupled together by a system bus or other interconnections 212 and may be present on one or more circuit boards such as circuit board 220. In some embodiments, the components may be integrated into a single chip. The chip may be silicon-based.

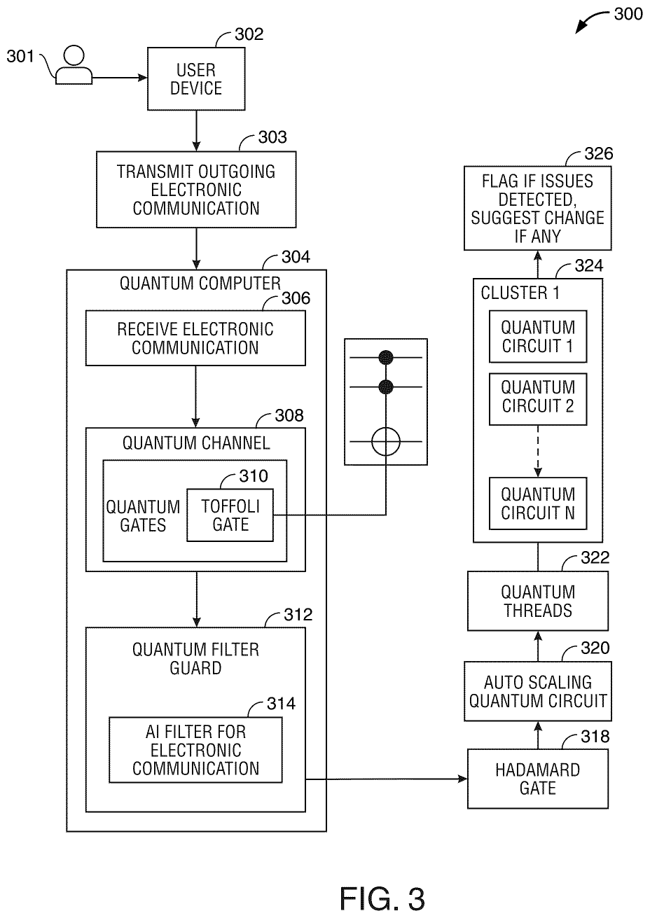

FIG. 3 shows illustrative diagram 300 in accordance with principles of the disclosure. Diagram 300 shows architecture and process steps of a quantum computing system that may perform filtering of outgoing electronic communications.

An electronic communication may be generated at a user device 302. The electronic communication may be generated by a user and may be readied for transmission to a recipient at a second user device.

At 303, the user device may initiate the transmission of the outgoing electronic communication. A copy of the electronic communication may be transmitted to the quantum computing system 304. The forwarding of the electronic communication to the recipient may not be completed until after the AI filtering of the electronic communication. Thus, the user may initiate the AI filtering of the outgoing electronic communication before the electronic communication is transmitted to the second user device via an electronic communication transmission system, such as an email system on the Internet or on an Intranet. The initiation of the AI filtering may be performed after the user selects a transmit option to cause the electronic communication to be transmitted to the second user device only after being filtered and authorized for transmission. The transmit option may cause the electronic communication to be filtered and transmitted immediately, if no changes to the electronic communication are noted by the AI filter. The authorization for transmission may be performed by the quantum computing system. The authorization may alternatively be performed by the user at the user device after the electronic communication is filtered by the quantum computing system. In that case, the initiation of the AI filtering may cause filtering to be performed, but may not transmit the electronic communication, until the user has received a confirmation that the outgoing electronic communication has been checked by the filter and verified as acceptable to transmit.

At 306, the electronic communication may be received at the quantum computing system and may be routed to quantum channel 308, which may include Toffoli gate 310. The system may select quantum filter guard 312. Quantum filter guard 312 may include an AI filter that may filter the electronic communication 314. The filtering may be performed using an AI model that has been trained using an electronic record of historical communications for this user. The electronic record may include past communications transmitted from the user device or received at the user device. The electronic record may be stored at the quantum computing system 304 or may be stored elsewhere, such as at the user device. The filtering may be performed by a quantum processor.

The quantum processor may include Hadamard gate 318. The quantum processor may include automatic scaling 320, wherein the processor may be initialized with a default size that may include a number of quantum threads 322. Each thread may include a cluster of quantum circuits 324. The scaling may include dynamically adjusting the number of threads and/or circuits based on the present computing task. At 326, an electronic communication that has been filtered may be transmitted to the intended recipient if no issues are identified by the AI filtering engine.

However, if issues are identified by the AI filtering engine, the outgoing electronic communication transmission may be flagged and may be blocked from further transmission. The flagged electronic communication may be returned to the user device for review and possible revision. The AI filtering engine may also suggest changes to the flagged electronic communication that may be based on the electronic record of historical communications for this user. The user of the user device that receives a flagged electronic communication may authorize the transmission of the electronic communication as is without changes.

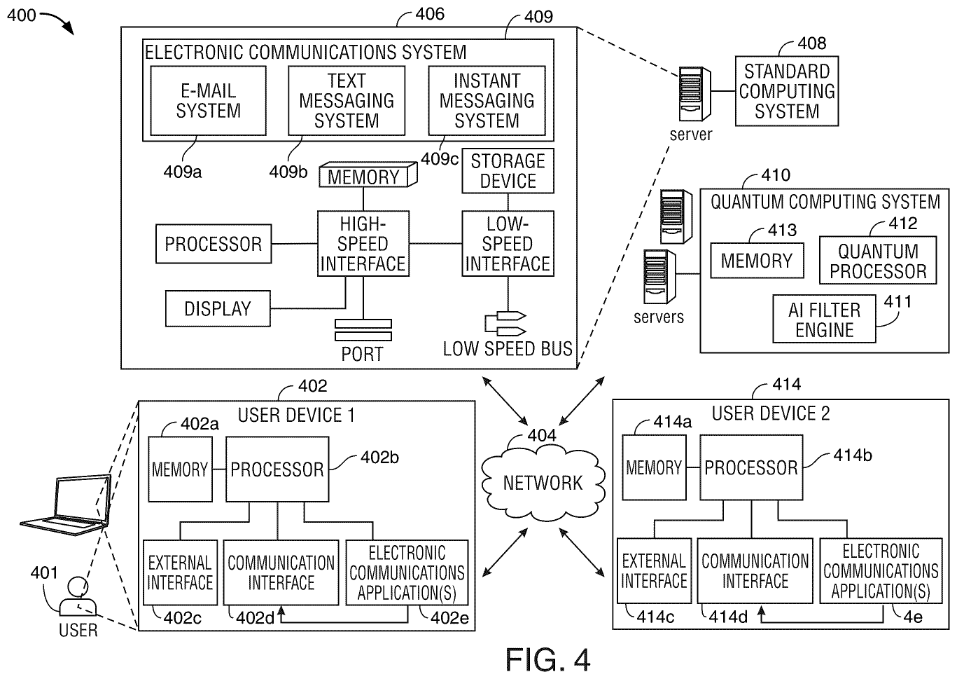

FIG. 4 shows illustrative architecture diagram 400 in accordance with principles of the disclosure. Diagram 400 includes a first user device 402 which may be used by a user 401, possible additional user devices, such as user device 414 for use by a second user, a standard computing system 408, and a quantum computing system 410 that may include an AI filter engine 411. User device 402 may include a memory 402a, processor 402b, external interface 402c, communication interface 402d, and an electronic communications application 402e, such as an email application, a text messaging application, or an instant messaging application. User device 414 may include a memory 414a, processor 414b, external interface 414c, communication interface 414d, and one or more electronic communications applications 414e. These devices and computing systems may be in communication with each other via network 404. Network 404 may be, for example, an Intranet, the Internet, or a cloud network.

Standard computing system 408 may include hardware 406, including memory, a processor, a display, high-speed and low-speed interfaces, connection ports, and suitable memory devices and communication busses. Standard computing system 408 may include an electronic communications system 409 that may operate one or more applications for conducting electronic communications. For example, electronic communications system 409 may include one or more of an email system 409a, a texting system 409b, or an instant messenger system 409c. Electronic communications may be conducted between user devices 402, 414 over network 404. The communications may be routed through electronic communications system 409 on standard computing system 408 that operates on a server.

The system may further include quantum computing system 410 that executes various computing tasks according to the methods and configurations disclosed herein. Quantum computing system 410 may include an AI filter engine 411 that may filter electronic communications generated by user devices 402, 414. Electronic communications may pass through electronic communications system on standard computing system 408 for transmission to a recipient. Quantum computing system 410 may include a quantum processor 412 and a memory 413.

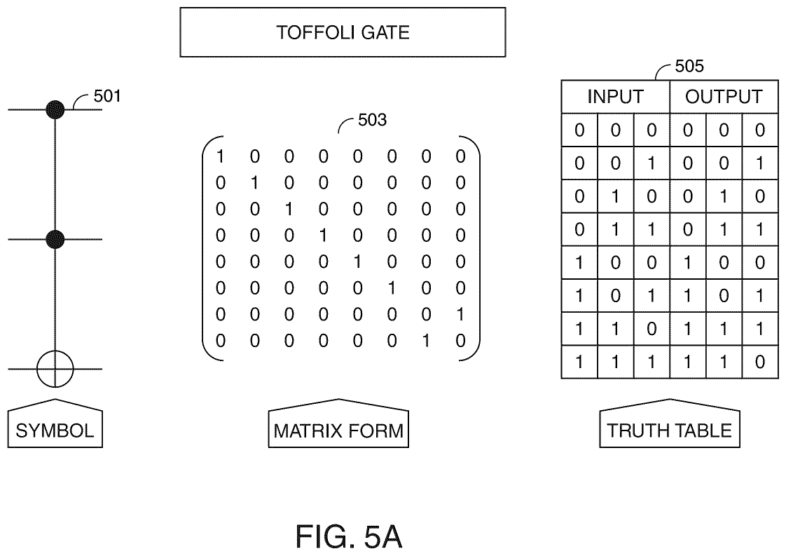

FIG. 5A-5B show illustrative diagrams of exemplary quantum gates in accordance with principles of the disclosure.

FIG. 5A shows symbol 501, matrix form 503, and truth table 505 of a Toffoli gate. A Toffoli gate is a universal reversible logic gate, which means that it enables simulation of any standard reversible circuit. In operation, as seen in truth table 505, the Toffoli gate has a 3-bit input and 3-bit outputs. The first two output bits always mirror the first two input bits. The third bit also stays the same unless the first two input bits are both set to 1—in which case the third output bit is inverted from the third input bit. The Toffoli gate is therefore also known as the “controlled-controlled-not” gate.

FIG. 5B shows representations of a Hadamard gate. Symbol 507 shows a representation of electron spin up, which corresponds to the value 1. Symbol 509 shows a representation of electron spin down, which corresponds to the value 0. Symbol 511 shows a representation of electron spin up and down, which corresponds to the value that represents a superposition of 1 and 0.

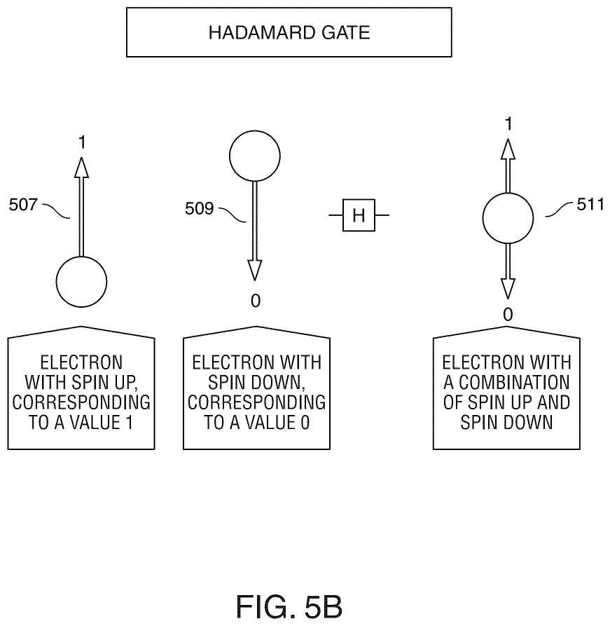

FIG. 6 shows illustrative diagram 600 in accordance with principles of the disclosure. Diagram 600 shows scaling of a quantum processor as disclosed herein. In an illustrative default initialization, the quantum processor may include a first quantum thread T1 that includes quantum circuits 601-603 and a second quantum thread T2 that includes quantum circuits 604-606. When the system detects a need for more processing power, a third quantum thread T3 may be added which may include quantum circuits 607-609. When the system detects a need for more processing time, quantum circuits 610 and 611 may be added to existing threads T1 and T2.

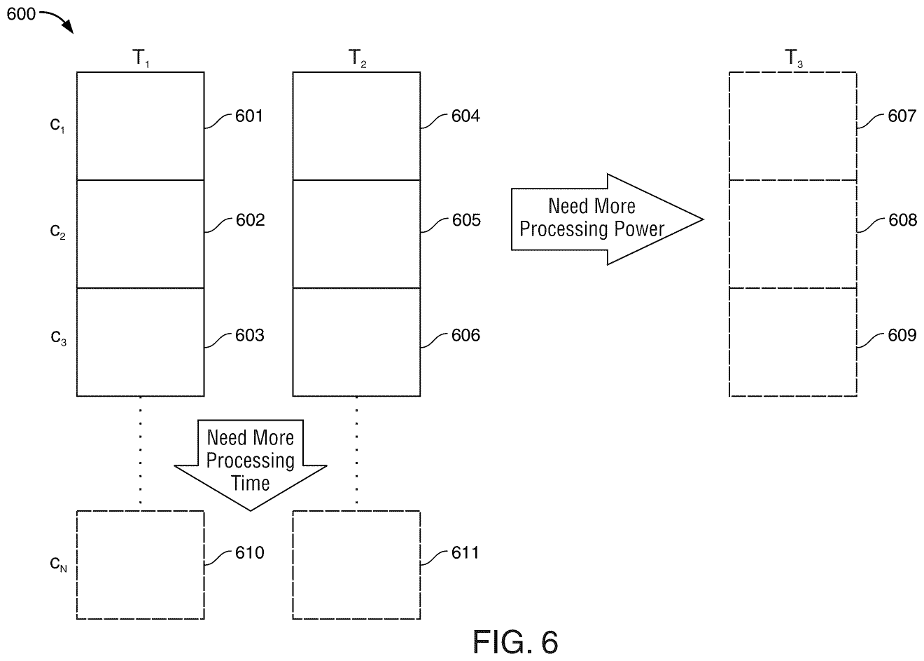

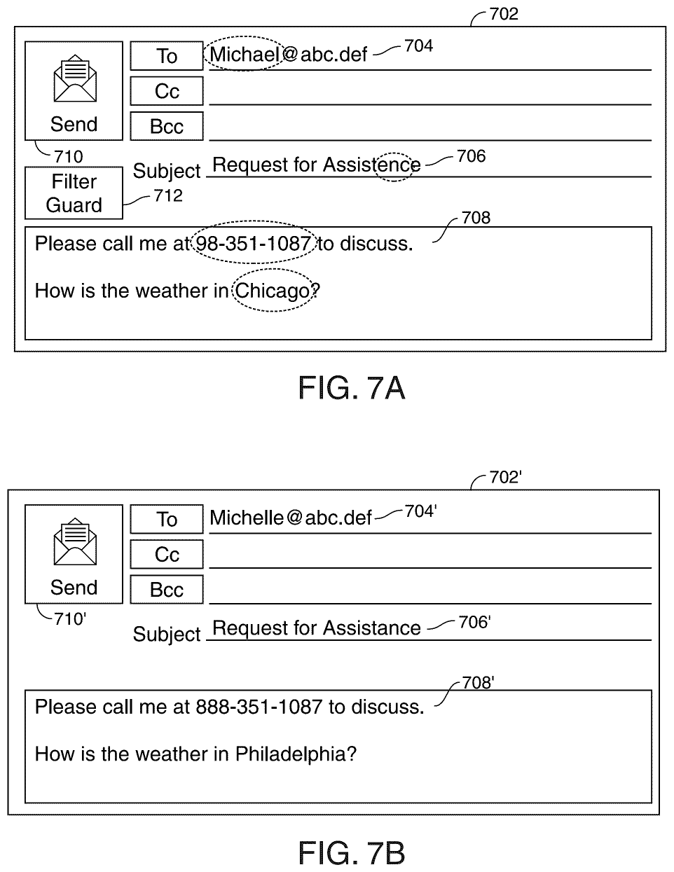

FIGS. 7A and 7B show an illustrative example of how AI-filtering may be performed on a quantum computing system and may be used to analyze a filtered email that has been flagged by the AI-filter based on an electronic record of historical electronic communications from the user.

FIG. 7A shows an illustrative email that has been flagged for attention. Email 700 may have been prepared by a user and transmitted from a user device. Email 700 may be transmitted to an email communications system on an email server at a standard computing system. Email 700 may also be received by an AI filter engine at a quantum computing system, such as by transmission from the email server or by having the user device transmit the email directly simultaneously as the email is sent to the email server.

Before the email is forwarded by the email server to a recipient, the email may be transmitted through the AI filter engine to check email 700 for mistakes. The AI filter engine may have been trained to check the email with reference to an electronic record of historical electronic data for the user (sender) of the email. The electronic record may include a compilation of information that reflects past emails, texts, instant messages or other data that may be analyzed by the AI filter engine. The historical electronic data may include data such as a listing of recipients, contact information for the recipients and other information correlated to each recipient or a group of recipient, such as topics that have been discussed or words or phrases used with each recipients, as well as information related to the user. The email may also be checked by the filter for typos and other incorrect information, based on the historical electronic data. The electronic record of historical electronic data may be stored at the quantum computer, the standard computer, or at a user device, or elsewhere, such as on a data store on the network.

Potential errors that have been identified by the filter may be specified to the user on the user device. The errors may be highlighted in some way, such as with color coding or an outline around the error. In this example, possible errors in email 700 that have been flagged include: (1) the recipient email address 704 which refers to michael@abc.def; (2) a typo in the subject line 706, (3) a wrong phone number for the sender; and (4) an incorrect location for the intended recipient in text box 708. These errors may be actual errors or may be identified as possible errors to be checked. Suggested corrections for the errors may be displayed to the user, such as with highlighting, listing the suggestions on a side of the email, or other ways to highlight the suggested changes. The user may initiate an AI filtering of the email 702 shown in FIG. 7A by clicking on an on-screen Send button 710. The Send button may be configured to allow the email to be transmitted to the recipient after AI filtering without a further action on the part of the user if the email is not flagged. The email may be flagged and returned to the user for possible modification. Alternatively, the AI filtering at the quantum computing system may be initiated by having the user select a separate Filter Guard button 712.

FIG. 7B shows an illustrative example of the same email of FIG. 7A after corrections have been made. Email 702 may have been corrected by the user, such as based on the suggestions. In corrected email 702′, the subject line, “michael” has been changed to “michelle” 704′, “Request for Assistance” has been corrected to Request for Assistance 706′, and the sender's phone number has been corrected, and the city has been changed from Chicago to Philadelphia in text box 708′. (Previous emails from the user may have asked Michelle about the weather in Philadelphia where Michelle is located, not Chicago.) The corrected email may then be transmitted to the recipient upon hitting a button, such as a send button 710′.

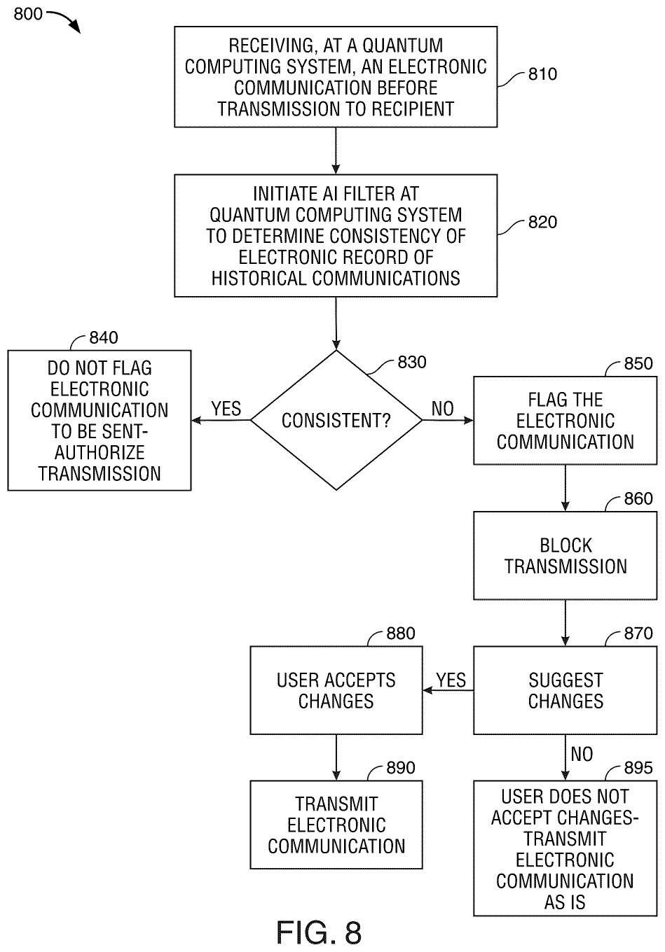

FIG. 8 shows illustrative process flow 800 for filtering electronic communications using an AI filtering engine at a quantum computing system. The electronic communications system may filter all electronic communications from a user or multiple users. The electronic communications to be filtered may be of one type, such as emails, or of multiple types of electronic communications, such as emails, text messages, and instant messages.

At step 810, a quantum computing system may receive an electronic communication that has been prepared, and may have been initiated for transmission by a user before the electronic communication is transmitted by the electronic communications system to the recipient(s) specified by the user.

At step 820, an AI filter may be initiated at the quantum computing system upon receipt of the electronic communication. The AI filter may determine consistency of the electronic communication with an electronic record of historical communications with the user. The filter may check, for example, names, addresses and other contact information, locations, topics, spellings of words, words and phrases used previously in communications by the user with the specified recipient or various recipients, other types of content of the electronic communications, or other examples of information described above. The determination may be performed quickly by the quantum computing system relative to a standard computing system so that any transmission delays in the electronic communications may not be noticeable.

At step 830, if the AI filter has determined that there are no issues of consistency, the user may be notified at the user device. At step 840, the filtered electronic communication may be authorized for transmission to the specified recipient(s). The authorization may be sent to the electronic communications system at the standard computer system, or an electronic communications system at the quantum computing system may transmit the electronic communication to the recipient. The authorization may include an indication that a review was successfully conducted, and that the electronic communication is approved for transmission.

If the AI filter has determined that that the electronic communication that is analyzed is not consistent with the electronic record of historical communications, at step 850, the electronic communication may be flagged. At step 860, a flagged electronic communication may be blocked from transmission, until further authorization for transmission is provided. At step 870, the user may be notified that the electronic communication has been flagged, and suggested changes may be provided to the user. At step 880, the user may adopt one or more of the suggested changes and, at step 890, may transmit the electronic communication. (The AI filter may be configured to optionally recheck the electronic communication.) The quantum computing system may be alerted to the changes that have been accepted. Alternatively, at step 895, the user may choose to transmit the electronic communication as is, without making any changes. The quantum computing system may be alerted to the transmission without accepting changes.

Thus, methods, apparatus, and computer-readable media for an AI filtering engine implemented on a quantum computing system are provided for filtering outgoing electronic communications before they are released to be sent to the recipients. Persons skilled in the art will appreciate that the present invention can be practiced by other than the described embodiments, which are presented for purposes of illustration rather than of limitation, and that the present invention is limited only by the claims that follow.

What is claimed is:

1. One or more non-transitory computer-readable media storing computer-executable instructions, which, when executed on a quantum processor on a computer system, perform a method for filtering outgoing electronic communications generated at a user device prior to transmission to recipients using artificial intelligence (AI) operating in a quantum computing environment, the method comprising:
receiving, at a quantum computing system comprising a quantum processor, an electronic communication of the outgoing electronic communications to be transmitted from a first user device to a second user device;
initiating, by the quantum processor, an AI filter engine for analyzing the electronic communication that is received in order to determine whether the electronic communication of a user of the first user device is consistent with an electronic record of historical communications in which the user has engaged;
wherein the quantum processor processes data as a plurality of qubits;
when the quantum processor determines that the electronic communication is consistent with the electronic record of historical communications, authorizing, by the AI filter engine, the electronic communication to be transmitted to the second user device; and
when the quantum processor determines that the electronic communication is inconsistent with the electronic record of historical communications, flagging, by the AI filter engine, the electronic communication for review.

2. The media of claim 1, wherein:
the AI filter engine comprises an AI model that has been trained with the electronic record of historical communications in which the user has engaged by reviewing contents of each of the outgoing electronic communications; and
the step of initiating, by the quantum processor, an AI filter engine for analyzing the electronic communication comprising analyzing, by the quantum processor, the electronic communication that is received to determine whether the electronic communication is consistent with the AI model.

3. The media of claim 2, wherein the analyzing of the electronic communication by the quantum processor to determine consistency of the electronic communication with the electronic record comprises checking the electronic communication for incorrect or missing information.

4. The media of claim 3, wherein the incorrect information includes one or more of an incorrect email address or phone number, an incorrectly identified recipient, spelling or grammatical mistakes, an incorrect attachment, or inappropriate or undesirable information.

5. The media of claim 1, further comprising:
blocking, by the quantum processor, a flagged electronic communication from being transmitted to the second user device.

6. The media of claim 1, further comprising:
returning a flagged electronic communication to the first user device and not transmitting the flagged electronic communication to the second user device.

7. The media of claim 1, further comprising:
suggesting, by the AI filter engine to the first user device, changes to a flagged electronic communication based on the electronic record to make the flagged electronic communication consistent with the electronic record to enable the flagged electronic communication to be transmitted to the second user device.

8. The media of claim 1, further comprising:
when the quantum processor determines that the electronic communication is consistent with the electronic record of historical communications, transmitting the electronic communication to the second user device; and
updating the electronic record of historical communications upon transmission of the electronic communication.

9. The media of claim 1, wherein the electronic record of historical electronic communications includes one or more of emails, text messages, or instant messages.

10. The media of claim 1, wherein the quantum processor analyzes the electronic communication in real time.

11. A method for filtering outgoing electronic communications generated at a user device prior to transmission to recipients using artificial intelligence (AI) operating in a quantum computing environment, the method comprising:
receiving, at a quantum computing system comprising a quantum processor, an electronic communication of the outgoing electronic communications to be transmitted from a first user device to a second user device before the transmission is performed;
initiating, by the quantum processor, an AI filter engine for analyzing the electronic communication that is received in order to determine whether the electronic communication of a user of the first user device is consistent with an electronic record of historical communications in which the user has engaged;
wherein the quantum processor processes data as a plurality of qubits;
when the quantum processor determines that the electronic communication is consistent with the electronic record of historical communications, authorizing, by the quantum processor, the electronic communication to be transmitted to the second user device; and
when the quantum processor determines that the electronic communication is inconsistent with the electronic record of historical communications, flagging, by the quantum processor, the electronic communication for review.

12. The method of claim 11, wherein:
the AI filter engine comprises an AI model that has been trained with the electronic record of historical communications in which the user has engaged by reviewing contents of each of the outgoing electronic communications; and
the step of initiating, by the quantum processor, an AI filter engine for analyzing the electronic communication comprising analyzing, by the quantum processor, the electronic communication that is received to determine whether the electronic communication is consistent with the AI model.

13. The method of claim 11, wherein the analyzing of the electronic communication by the quantum processor to determine consistency of the electronic communication with the electronic record comprises checking the electronic communication for incorrect or missing information.

14. The method of claim 13, wherein the incorrect information includes one or more of an incorrect email address or phone number, an incorrectly identified recipient, spelling or grammatical mistakes, an incorrect attachment, or inappropriate or undesirable information.

15. The method of claim 11, further comprising:
blocking, by the quantum processor, a flagged electronic communication from being transmitted to the second user device.

16. The method of claim 11, further comprising:
returning a flagged electronic communication to the first user device and not transmitting the flagged electronic communication to the second user device.

17. The method of claim 11, further comprising:
suggesting, by the AI filter engine to the first user device, changes to a flagged electronic communication based on the electronic record to make the flagged electronic communication consistent with the electronic record to enable the flagged electronic communication to be transmitted to the second user device.

18. The method of claim 11, further comprising:
when the quantum processor determines that the electronic communication is consistent with the electronic record of historical communications, transmitting the electronic communication to the second user device; and
updating the electronic record of historical communications upon transmission of the electronic communication.

19. The method of claim 11, wherein the electronic record of historical electronic communications includes one or more of emails, text messages, or instant messages.

20. The method of claim 11, wherein the quantum processor analyzes the electronic communication in real time.
